(19) United States
(12) Patent Application Publication
(10) Pub. No.: US 2022/0365204 A1
(43) Pub. Date: Nov. 17, 2022

(54) STAND-OFF SCREENING SYSTEM

(71) Applicant: ICONAL TECHNOLOGY LTD., Cambridge Cambridgeshire (GB)

(72) Inventors: Samuel Pollock, Cambridge Cambridgeshire (GB); Michael Charles Kemp, Cambridge Cambridgeshire (GB); Daniel Robert Crick, Cambridge Cambridgeshire (GB)

(73) Assignee: ICONAL TECHNOLOGY LTD., Cambridge Cambridgeshire (GB)

(21) Appl. No.: 17/596,441

(22) PCT Filed: Jun. 16, 2020
(86) PCT No.: PCT/EP2020/066593

§ 371 Date: Dec. 10, 2021

(30) Foreign Application Priority Data
Jun. 18, 2019 (GB) 1908730.3

(51) Int. Cl. G01S 13/88; G01S 15/88; G01S 13/89; G01S 13/86; G01G 9/00

(52) U.S. Cl. CPC G01S 13/887; G01S 15/88; G01S 13/89; G01S 13/862; G01G 9/00

(57) ABSTRACT

A system for stand-off screening of individuals and/or an item of baggage carried by an individual. The system including: a sensor array, the sensor array including: an optical sensor, configured to collect data indicative of a position of the individual and/or the presence and dimension of the item of baggage relative to the optical sensor; a first radar sensor, configured to collect data indicative of: properties of objects concealed under clothing worn by the individual and/or properties of one or more objects within the item of baggage; an acoustic sensor, configured to collect data indicative of: properties of objects concealed under clothing worn by the individual and/or properties of one or more objects within the item of baggage. The system also includes a processor, configured to combine the data collected from the optical sensor, the first radar sensor, and the acoustic sensor, and to derive a risk estimation for the individual and/or the item of baggage carried by the individual based on the combined data.

### FIELD OF THE INVENTION

The present invention relates to a system for stand-off screening of individuals and/or an item of baggage carried by an individual.

### BACKGROUND

The screening of individuals and their carried possessions in the context of, say, airports or sensitive buildings, has classically been dominated by the x-ray scanner and/or metal detection archway or hand-held wand. However such techniques, whilst suited to environments where individuals and their baggage can be channelled through a security check point, cannot easily be applied in other environments, such as for example, music venues, sporting events, public attractions, train station concourses or platforms, where a large number of individuals will pass through in any given period of time. In these is not acceptable to interrupt the so-called ‘normal flow of commerce’ by introducing significant delays to individuals, space for queuing is limited and screening must be carried out at a low cost per person screened.

Consequently, it is desirable to provide a system which operates in a substantially automated manner. That is, it is not feasible to require a trained operator who views each and every result of a scan.

Therefore, there is a need for a system which allows the stand-off screening of individuals and/or their baggage as they walk-by the system in an automated and high-throughput manner.

### SUMMARY

Accordingly, in a first aspect, the invention provides a system for stand-off screening of individuals and/or an item of baggage carried by an individual, including:
a sensor array, the sensor array including:
   an optical sensor, configured to collect data indicative of a position of the individual and/or the presence and dimension of the item of baggage relative to the optical sensor;
   a first radar sensor, configured to collect data indicative of:
   properties of objects concealed under clothing worn by the individual and/or
   properties of one or more objects within the item of baggage;
   an acoustic sensor, configured to collect data indicative of:
   properties of objects concealed under clothing worn by the individual and/or
   properties of one or more objects within the item of baggage;
the system also including:
a processor, configured to combine the data collected from the optical sensor, the first radar sensor, and the acoustic sensor, and to derive a risk estimation for the individual and/or the item of baggage carried by the individual based on the combined data.

Advantageously, such a system is able to perform stand-off screening of individuals and/or their baggage in an automated and high-throughput manner. For example, some embodiments are capable of screening an individual and/or their baggage in less than 4 seconds.

Optional features of the invention will now be set out. These are applicable singly or in any combination with any aspect of the invention.

The system may further comprise d a mass sensor of the sensor array configured to utilise the Doppler effect and vibrations of the item of baggage to collect data indicative of a mass of the item of baggage and contents therein. This data indicative of mass may be used by the processor in its derivation of a risk estimation. The mass sensor may be the acoustic sensor. The vibrations may be those generated by the individual as they move. The system may further comprise a vibration mechanism, configured to induce vibrations in the item of baggage.

The first radar sensor is generally operable to identify large metallic objects or metal containing objects with an item of baggage or placed under clothing of an individual. The mass sensor is generally operable to determine the mass of objects within an item of baggage or items placed under clothing of an individual, and so the nature of these objects can be better ascertained. The optical sensor is generally operable to identify a person's position, whether they carry an item of baggage, and the dimensions of the item of baggage.

The optical sensor may also collect data indicative of the size, height, shape, and/or posture of the individual. Preferably, the first radar sensor may collect data indicative of properties of objects concealed under clothing worn by the individual and properties of one or more objects within the item of baggage. Said another way, preferably the first radar sensor may collect data indicative of properties of all objects within its scanning field.

The mass sensor may be a second radar sensor. The second radar sensor may operate at a frequency of at least 1 GHz and no more than 300 GHz; at least 5 GHz and no more than 50 GHz; at least 3 GHz and no more than 65 GHz; at least 3 GHz and no more than 100 GHz, or, preferably, at least 20 GHz and no more than 30 GHz.

The mass sensor may be an ultrasound sensor. Advantageously, such a sensor is able to reliably identify items of baggage which are mostly empty/have only a few objects within whilst also allowing the identification of dense, heavy objects which fill an item of baggage or are concealed under an item of clothing.

The system may further include a sonar sensor, which may be configured to sense data indicative of a ranging of the objects concealed under clothing worn by the individual or within the item of baggage. The system may further include an ultrasound source, and ultrasound sensor which is configured to collect further data indicative of properties of and size of objects concealed under clothing worn by the individual and/or further properties of and size of one or more objects within the item of baggage. The ultrasound sensor may further be configured to collect data indicative of surface properties as well (e.g. is surface taught or loose, porous or stiff). The ultrasound sensor may include a plurality of microphones, and one or multiple sources of ultrasound. The processor may use a computational focusing technique on data collected from the plurality of microphones, to generate one or more virtual microphones.

The ultrasound sensor may operates at a frequency of at least 2 kHz, or at least 10 kHz and no more than 200 kHz, or at least 20 kHz and no more than 50 kHz.

The system may further include a 3D imaging radar, configured to generate a 3D radar profile of an area in which the device and individuals to be screened are situated. The 3D imaging radar may operate at a frequency of at least 1 GHz and no more than 300 GHz, or at least 1 GHz and no more than 50 GHz, or at least 3 GHz and no more than 10 GHz. The 3D imaging radar may be the second radar sensor operating in a 3D imaging mode.

The system may further include a dual polarisation radar sensor, configured to measure data indicative of a presence of metallic contents of the item of baggage or items concealed under clothing using the relative magnitude and position in range of co- and cross-polarised radar returns. The dual polarisation radar sensor may be provided via the first radar sensor, operated in a dual polarisation mode. The first radar sensor may operate simultaneously or sequentially in a first mode in which data indicative of: properties of objects concealed under clothing worn by the individual and/or properties of one or more objects within the item of baggage is collected, and a second mode in which data indicative of a presence of metallic contents of the item of baggage or items concealed under clothing is collected. The dual polarisation radar sensor may be provided as a discrete unit, separate from the first radar sensor.

The vibration mechanism may operate at a frequency of at least 10 Hz and no more than 1000 Hz, or at least 30 Hz and no more than 120 Hz, or harmonics thereof.

The vibration mechanism may be a speaker, for example an electromechanical or preferably and electroacoustic transducer.

The processor may use a machine learning algorithm to derive the risk estimation for the individual and/or the item of baggage carried by the individual based on the combined data.

The first radar sensor may be configured to operate at a frequency of at least 20 GHz and no more than 70 GHz.

The system may further include a laser and laser sensor, and the system may be configured to illuminate the item of baggage with the laser and collect data indicative of a mass of the item of baggage and contents therein using the laser sensor.

The processor may be configured to combine the data using weighting factors associated with each of sensors.

The sensors may be dispersed between two or more devices, with at least one sensor in each device, wherein a scanning direction of any one device overlaps with a scanning direction of the other devices, such that a front of the individual and a back of the individual can be scanned simultaneously, or in succession. The time between successive scans may be relatively small.

The system may include two devices, and each device may include a sensor array.

The sensor array may be installed in a single device, and the system may include a track for individuals which guides each individual along a U-shaped path such that a front of the individual and a back of the individual can be scanned separately.

In a second aspect, the invention provides a method of stand-off screening of individuals and/or items of baggage carried by individuals, using the system of the first aspect, the method including the steps of:
using the sensor array to collect:
   data indicative of a relative position of the individual and/or the presence and dimension of the item of baggage;
   data indicative of properties of objects concealed under clothing worn by the individual and/or properties of one or more objects within the item of baggage from both the first radar sensor and the acoustic sensor; and
generating a risk estimation for the individual and/or the item of baggage carried by the individual based on the combined data.

The method may include using the vibration mechanism provided in some examples of the first aspect to induce vibrations in the item of baggage. In some examples, the sensor array may collect data indicative of a mass of the item of baggage and contents therein.

In a third aspect, the invention provides a system for stand-off screening of individuals and/or items of baggage carried by individuals comprising:
an optical sensor, configured to collect data indicative of a relative position of an individual and/or the presence dimension of an item of baggage; and any two of the following sensors:
a first radar sensor, configured to collect data indicative of:
   properties of and size of objects concealed under clothing worn by the individual; and/or
   properties of and size of one or more objects within the item of baggage;
a second radar, configured to utilise the Doppler effect, in response to vibrations induced by a vibration mechanism, to collect data indicative of a mass of the item of baggage and contents therein;
a microwave scanner, configured to generate a 3D radar profile of an area in which the device is situated, and individuals within the area; and
an ultrasound sensor, configured to collect data indicative of:
   properties of and size of objects concealed under clothing worn by the individual and/or
   properties of and size of one or more objects within the item of baggage.

The system of the third aspect may have any, or any combination insofar as they are compatible, of the features of the first aspect.

### BRIEF DESCRIPTION OF THE DRAWINGS

Embodiments of the invention will now be described by way of example with reference to the accompanying drawings in which:

FIG. 1 shows a system;

FIGS. 2a-2c show a series outputs of an optical sensor;

FIG. 3 shows a plot of acoustically stimulated displacement against frequency for: an empty bag, a bag containing a threat item, and background motion without any acoustic stimulus;

FIGS. 4a-4d show the radar returns from a 57-64 GHz radar sensor for two benign items of baggage, and two items of baggage containing one or more threat items;

FIG. 5a-5d show the radar returns from a 6-8 GHz radar sensor for two benign items of baggage, and two items of baggage containing one or more threat items;

FIGS. 6a and 6b show 3D plotted radar returns from the 6-8 GHz radar sensor for a benign item of baggage and an item of baggage containing one or more threat items;

FIG. 7 shows an example of the system of FIG. 1 located in two devices; and

FIG. 8 shows an example of the system of FIG. 1 located in a single device.

### DETAILED DESCRIPTION AND FURTHER OPTIONAL FEATURES

Aspects and embodiments of the present invention will now be discussed with reference to the accompanying figures. Further aspects and embodiments will be apparent to those skilled in the art. All documents mentioned in this text are incorporated herein by reference

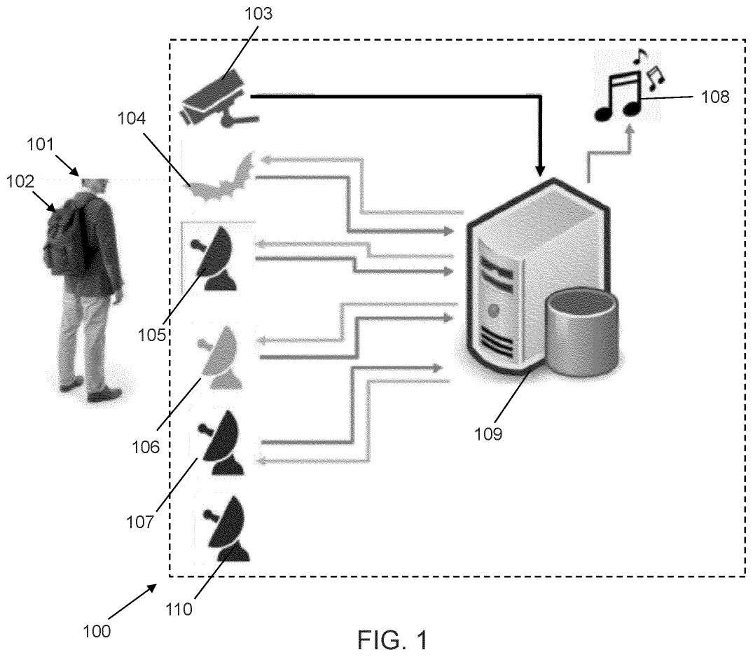

FIG. 1 shows a system 100 for stand-off screening of individuals 101 and items of baggage 102 carried by an individual. Generally, the system includes a sensor array comprising: an optical sensor 103, an ultrasound sensor 104, a first radar sensor 105, a second radar sensor 106, a dual polarisation radar sensor 107; and a 3D imaging radar 110. The system also includes a processor 109 within e.g. a computer. Each of the optical sensor, ultrasound sensor, first radar sensor, second radar sensor, and dual polarisation radar sensor provide data to a processor 109. Data from all or a subset of the sensors is combined by the processor, and a risk estimation is derived for the individual and/or the item of baggage carried by the individual based on the combined data.

The system 100 also includes a vibration mechanism 108, controlled by the processor 109, which induces vibrations in the item of baggage for the mass sensor. In this example, the vibration mechanism is an electromagnetic transducer which emits sound waves. As is discussed in more detail below, these induced vibrations can be used to estimate the mass of the item of baggage.

Whilst the system shown in includes many sensors it will be appreciated that, for example, ultrasound scanner 104, second radar sensor 106, and dual polarisation radar sensor 107 may be omitted.

Each of the sensors operates as a standalone module, in that they autonomously collect their respective data at the highest possible sample rate. In some examples, some pre-processing of the data is performed, in real time, by a processor located within each module or by the processor 109. The data captured by each sensor is then streamed to the processor 109 and stored e.g. in a hard drive or other storage medium. The pre-processing may include filtering and cleaning up of the captured data by, for example, subtracting any stored background or calibration measurements.

The processor 109 also ensures that the data received from each sensor is temporally and spatially aligned, e.g. to less than 10 cm spatial variance and less than 50 ms or preferably less than 10 ms temporal variance. The processor 109 then passes this data to an algorithm which derives a risk estimation for the individual and/or item of baggage which has been scrutinised by the sensors. The algorithm is preferably a machine learning algorithm e.g. logistic regression, neural networks, support vector machines, and/or decision trees and random forests. Preferably the machine algorithm is an implementation of a random forest model. The processor may also use, in addition or as an alternative to the machine learning algorithm, a statistical classifier such as principal component analysis.

Whilst a single processor 109 is shown in FIG. 1, it will be appreciated that the functions performed by the processor may be divided between any number of processors. For example, in a variation of FIG. 1 a second processor (not shown) controls the vibration mechanism and receives data from only the dual polarisation radar sensor and second radar sensor. This second processor is synchronized with, and shares data with, the first processor.

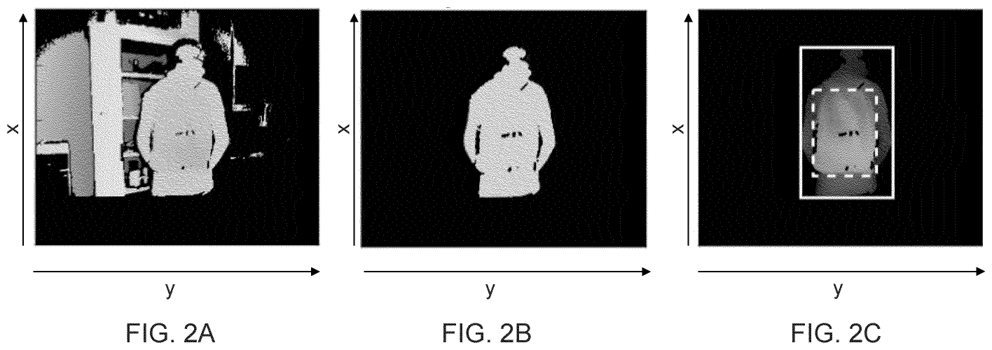

FIGS. 2a-2c show a series of outputs from the optical sensor 103. In this example, the optical sensor is a time of flight sensor. FIG. 2a shows an output of the original depth in the image, which includes an individual wearing an item of baggage standing in front of a backdrop. The processor can then identify all objects in the frame, i.e. those elements which do not constitute the backdrop. This is shown in FIG. 2b, where the individual an item of baggage have been identified as objects in the field of view of the optical sensor. Finally, as shown in FIG. 2c, the processor identifies the largest object in the image i.e. the individual and the item of baggage. The processor is also able to identify (based on a difference in distance) the item of baggage as distinct from the individual wearing it. The processor can also use the optical sensor to identify the size of the individual/item of baggage, the height of the individual, and their posture.

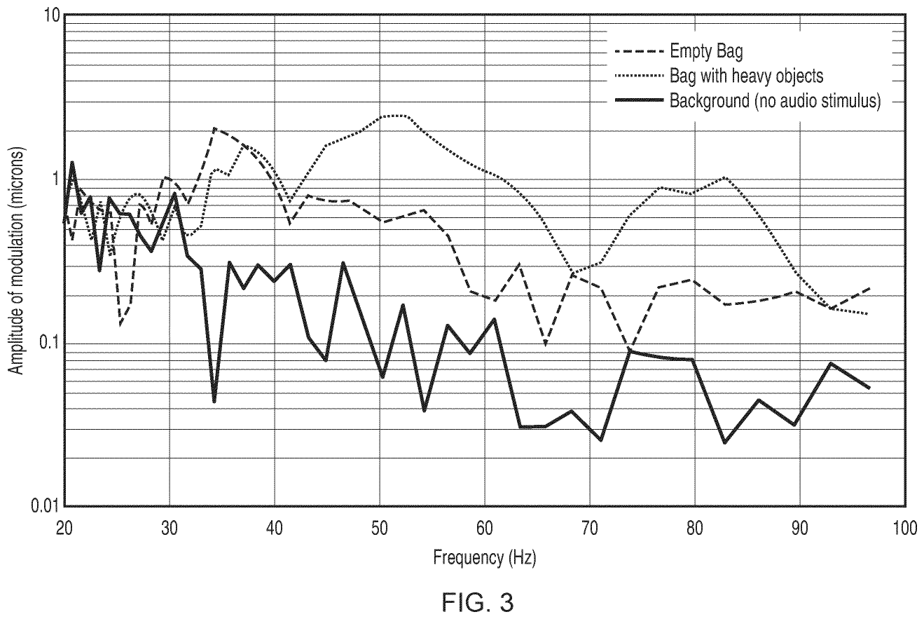

FIG. 3 shows a plot of acoustically stimulated displacement (in microns) as measured with an accelerometer against frequency for: an item of baggage containing a threat item (uppermost line at y=0); an empty item of baggage (middle line at y=0); and background motion when no acoustic stimulus is applied (bottom line at y=0).

As can be seen from the plot, an item of baggage containing items demonstrate a different displacement response in comparison to an empty item of baggage.

Fundamentally the induced motion of an object for a constant depends on the magnitude of the sound pressure levels, the cross sectional area of the object directed towards the direction of sound propagation and the mass of the object. Different objects inside a bag will thus move differently, and mechanically coupled or touching objects will move differently to those in relative isolation. With the sinusoidal acoustic stimulus, the displacement is approximately proportional to the square of the frequency of the stimulus and the inverse of the mass of the object (or coupled objects).

Sensing this motion with radar can be accomplished using a one of, or combination of three effects. Direct modulation of the phase of the reflected signal from in-plane vibrations, modulation of the overall reflected amplitude due to multiple reflections from objects moving differently, and modulation of effective radar cross section caused by intermittent contact of conductive objects.

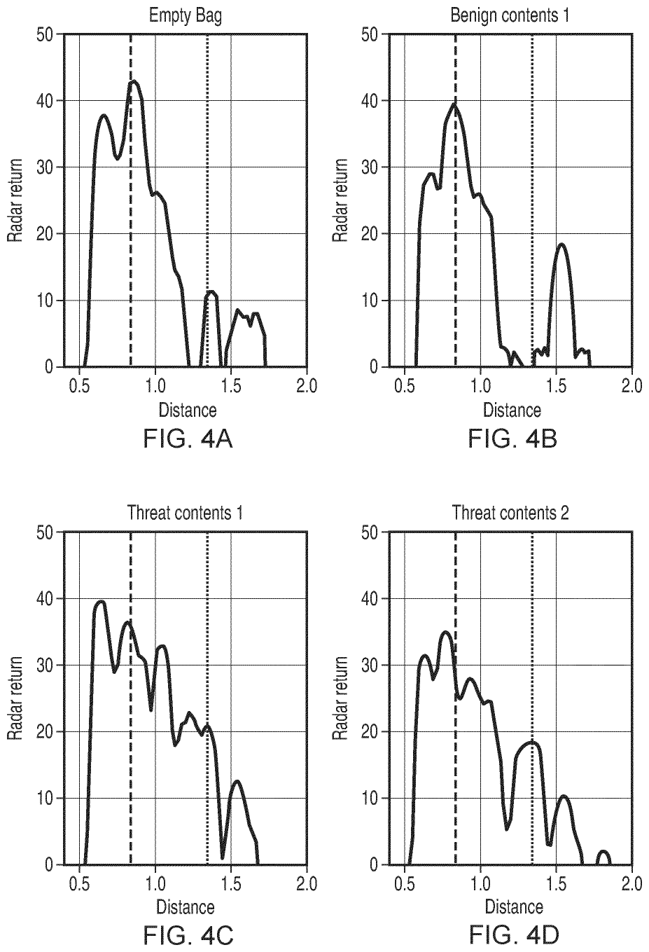

FIGS. 4a-4d show the radar returns from a 57-64 GHz radar sensor (an example of the first radar sensor discussed above) for two benign items of baggage (upper two plots) and two items of baggage containing one or more threat items. As can be seen, the radar return for the items of baggage containing one or more threat items are markedly different to the two benign items of baggage. As such, it is possible to identify items of baggage which are likely to contain threat items from the radar return.

For example, it was found that the data obtained 57-64 GHz radar sensor could be analysed with respect to estimated risk by reference to the following characteristics:
1— Total energy returned from scanned item
   Integrated energy from start of radar range through to the (estimated) position of a surface of the item of baggage adjacent the wearer;
   This is likely to be higher for objects with a high radar cross section (which is an indicator that the object is likely to be a certain class of threat items) than non-metallic benign items;
2— Late response
   Average radar return in a spatial region between the back of the torso and 50 cm behind the torso.
   This is likely to be higher for large objects with a high dielectric constant (which is a property associated with some types of threat item)
3—Peak torso response
   Average radar return in a 5 cm window centred on the (estimated) position of the back of the person being screened;
   This is used to classify empty bags as “clear”, as it allows the determination that there is no significant object in the bag opposing the view of the torso back.

Using this data, and the features discussed above, it was found that the data obtained from the 60 GHz radar sensor cleared bags with an accuracy of 86%.

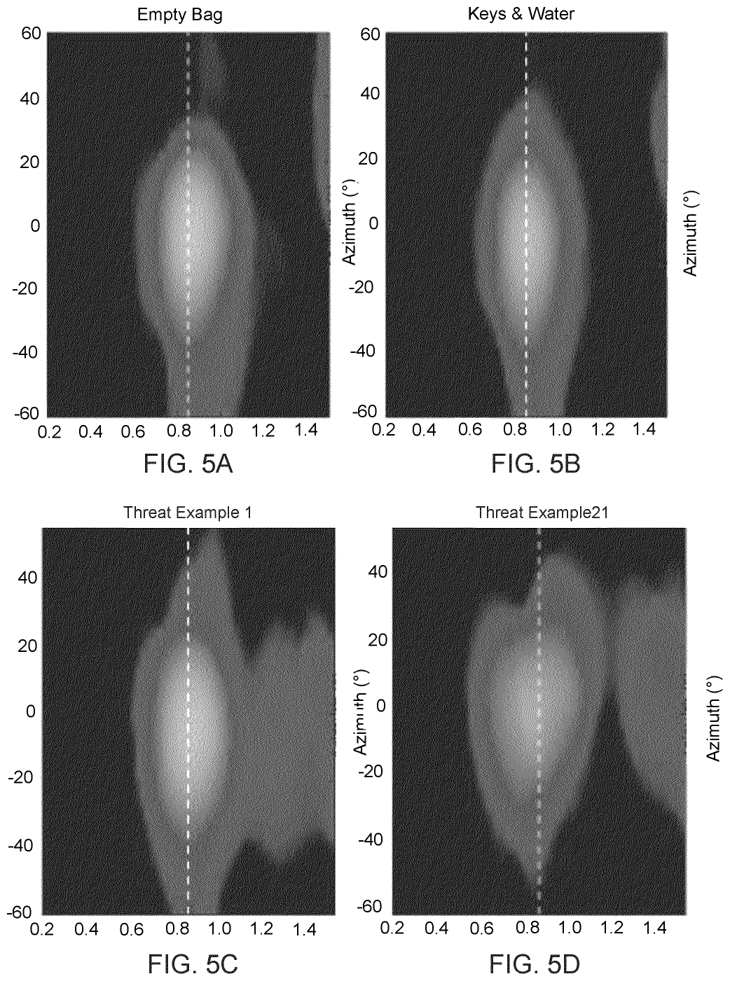

FIGS. 5a-5d show the radar returns from a 6-8 GHz radar sensor (an example of the second radar sensor discussed above) for two benign items of baggage and two items of baggage containing one or more threat items. Again, as can be seen, the radar return for the items of baggage containing one or more threat items are markedly different to the two benign items of baggage. As such, it is possible to identify items of baggage which are likely to contain threat items from the radar return.

For example, it was found that the data obtained from the 6-8 GHz radar sensor could be analysed with respect to estimated risk by reference to the following characteristics:
1—Number of slices (taken in a direction through the sample) identified as anomalous (i.e. substantially different from radar profiles measured on normal “benign” subjects);
2— Total radar return
   The overall radar reflection will vary for objects with different radar cross sections, for example metallic items which can cause specular reflection away from the sensor;
3—Ratio of energy in regards to range from radar
   Varies significantly according to any delayed radar returns coming from within partially transparent dielectric media;
4—Total amount of energy return from bag volume
   Low for threat type objects
5—Position of radar centre of mass relative to torso
   Either very close to clothing layer or substantially ‘behind’ torso for predominantly non-metallic threat objects.

Using this data, and the features discussed above, it was found that data obtained from the 6-8 GHz radar sensor reliably identified items of baggage/individuals carrying threat items whilst producing very few false positives.

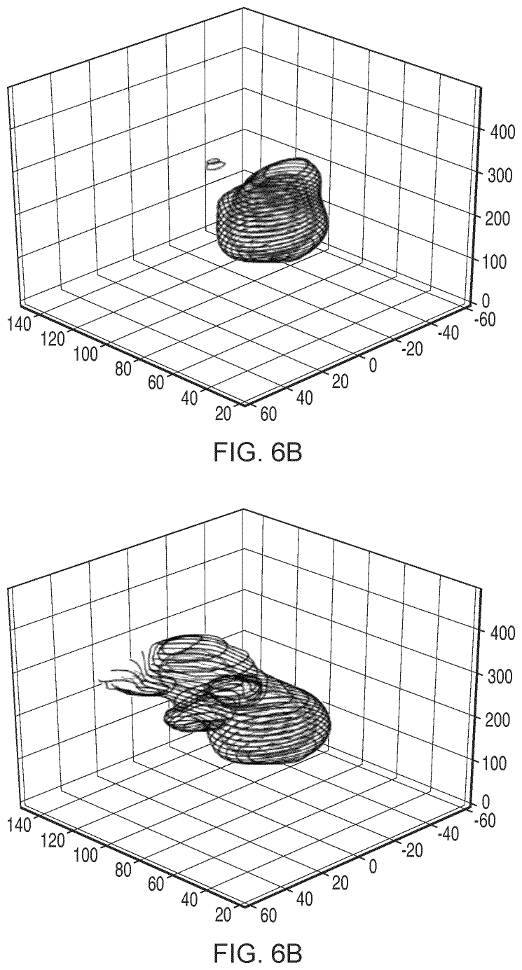

FIGS. 6a and 6b show 3D plotted radar returns from the 6-8 GHz radar sensor for a benign item of baggage (FIG. 6a) and an item of baggage containing one or more threat items (FIG. 6b). As can be seen, the radar return is markedly different between FIGS. 6a and 6b. As such, it is possible to identify items of baggage which are likely to contain threat items from the radar return.

The processor 109 can use either or both of the radar returns from the millimetre (e.g. 57-64 GHz) radar sensor and the microwave (e.g. 6-8 GHz) radar sensor when deriving the risk estimation.

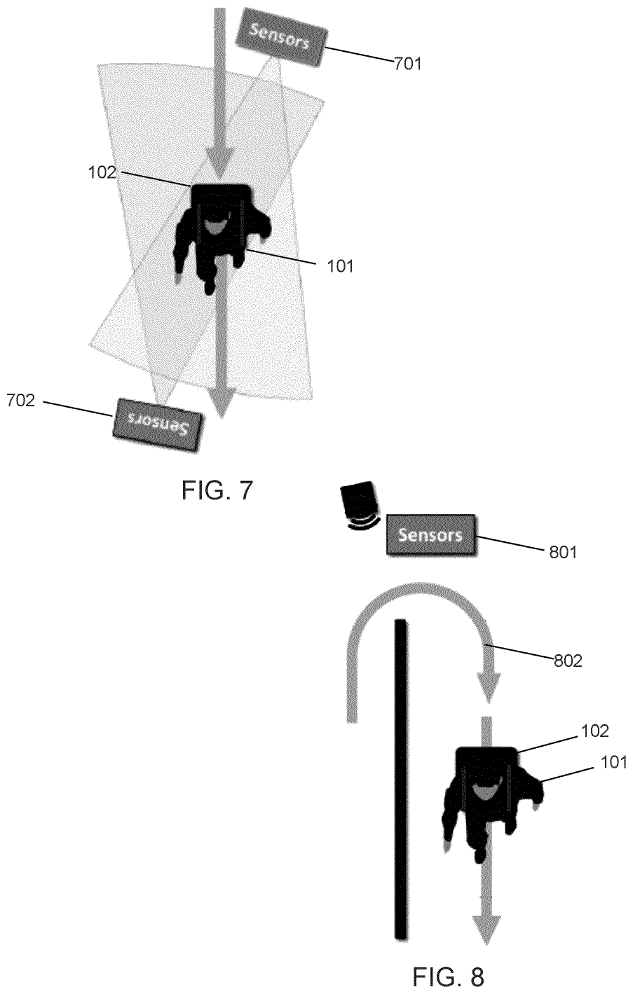

FIG. 7 shows an example of the system 100 where the sensor array has been split between two devices: a first device 701 and a second device 702. The individual 101, carrying the item of baggage 102, moves past both devices and therefore a front and rear of the individual (and the item of baggage) are therefore scanned by sensors located in the first and second device. This scanning can be performed simultaneously, or in sequence.

Preferentially the device which scans the rear of the individual, and therefore the item of baggage, would contain the sensors of the sensor array best suited for scanning the item of baggage. Alternatively, both devices may contain all of the elements of the sensor array discussed above.

FIG. 8 shows an example of the system 100 where the sensor array is installed in a single device 801, and where the system includes a track 802 along which the individual is guided. The track is generally U-shaped, and so as the individual walks towards the device 801 their front can be scanned by the sensor array. Whereas, once they turn the corner and walk away from the device 801, the item of baggage being carried/their back can be scanned using the same sensor array.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A system for stand-off screening of individuals and/or an item of baggage carried by an individual, including:
a sensor array, the sensor array including:
an optical sensor, configured to collect data indicative of a position of the individual and/or the presence and dimension of the item of baggage relative to the optical sensor;
a first radar sensor, configured to collect data indicative of:
properties of objects concealed under clothing worn by the individual and/or properties of one or more objects within the item of baggage;
an acoustic sensor, configured to collect data indicative of:
properties of objects concealed under clothing worn by the individual and/or properties of one or more objects within the item of baggage;
the system also including:
a processor, configured to combine the data collected from the optical sensor, the first radar sensor, and the acoustic sensor, and to derive a risk estimation for the individual and/or the item of baggage carried by the individual based on the combined data.

2. The system of claim 1, further comprising a mass sensor of the sensor array is configured to utilise the Doppler effect and vibrations of the item of baggage to collect data indicative of a mass of the item of baggage and contents therein.

3. The system of claim 2, wherein the mass sensor is a second radar sensor.

4. The system of claim 2, wherein the mass sensor is an ultrasound sensor.

5. The system of claim 3, wherein the second radar sensor operates at a frequency of at least 1 GHz, and no more than 300 GHz.

6. The system of claim 1, further including an ultrasound source, and ultrasound sensor which is configured to collect further data indicative of properties of and size of objects concealed under clothing worn by the individual and/or further properties of and size of one or more objects within the item of baggage.

7. The system of claim 6, wherein the ultrasound sensor includes a plurality of microphones, and a one or more sources of ultrasound.

8. The system of claim 7, wherein the processor uses a computational focusing technique on data collected from the plurality of microphones and sources, to generate one or more virtual microphones.

9. The system of claim 1, wherein the ultrasound sensor operates at a frequency of at least 2 kHz and no more than 200 kHz

10. The system of claim 1, further including a 3D imaging radar, configured to generate a 3D radar profile of the area and individuals in which the device is situated.

11. The system of claim 10, wherein the 3D imaging radar operates at a frequency of at least 1 GHz and no more than 300 GHz.

12. The system of claim 1, further including a dual polarisation radar sensor, configured to measure data indicative of a presence of metallic contents of the item of baggage or items concealed under clothing.

13. The system of claim 1, wherein the vibration mechanism operates at a frequency of at least 10 Hz and more than 1000 Hz.

14. The system of claim 1, wherein the vibration mechanism is a speaker.

15. The system of claim 1, wherein the processor uses a machine learning algorithm to derive the risk estimation for the individual and/or the item of baggage carried by the individual based on the combined data.

16. The system of claim 1, wherein the first radar sensor is configured to operate at a frequency of at least 20 GHz and no more than 70 GHz.

17. The system of claim 1, further including a laser and laser sensor, the system being configured to illuminate the item of baggage with the laser and collect data indicative of a mass of the item of baggage and contents therein using the laser sensor.

18. The system of claim 1, wherein the processor is configured to combine the data using weighting factors associated with each of sensors.

19. The system of claim 1, wherein the sensors are dispersed between two or more devices, with at least one sensor in each device, wherein a scanning direction of any one device overlaps with a scanning direction of the other devices, such that a front of the individual and a back of the individual can be scanned simultaneously, or in succession.

20. The system of claim 1, wherein the system includes two devices, and each device includes a sensor array.

21. The system of claim 1, wherein the sensor array is installed in a single device, and the system includes a track for individuals which guides each individual along a U-shaped path such that a front of the individual and a back of the individual can be scanned separately.

22. A method of stand-off screening of individuals and/or items of baggage carried by individuals, using the system of claim 1, the method including the steps of:
using the sensor array to collect:
data indicative of a relative position of the individual and/or the presence and dimension of the item of baggage;
data indicative of properties of objects concealed under clothing worn by the individual and/or properties of one or more objects within the item of baggage from both the first radar sensor and the acoustic sensor; and
generating a risk estimation for the individual and/or the item of baggage carried by the individual based on the combined data.

23. A system for stand-off screening of individuals and/or items of baggage carried by individuals comprising:
an optical sensor, configured to collect data indicative of a relative position of an individual and/or the presence dimension of an item of baggage; and any two of the following sensors:
a first radar sensor, configured to collect data indicative of:
properties of and size of objects concealed under clothing worn by the individual; and/or
properties of and size of one or more objects within the item of baggage;
a second radar, configured to utilise the Doppler effect, in response to vibrations induced by a vibration mechanism, to collect data indicative of a mass of the item of baggage and contents therein;
a microwave scanner, configured to generate a 3D radar profile of an area in which the device is situated, and individuals within the area; and
an ultrasound sensor, configured to collect data indicative of:
properties of and size of objects concealed under clothing worn by the individual and/or
properties of and size of one or more objects within the item of baggage.
